(19) United States
(12) Patent Application Publication
(10) Pub. No.: US 2002/0093834 A1
(43) Pub. Date: Jul. 18, 2002

(54) Light-effect producing candle

(76) Inventors: Chun-Chien Yu, Taipei (TW); Lap-Yan Ting, Taipei (TW); Jerry Chen, Taipei (TW); Chun-Lang Chen, Taipei (TW); Yu-Ching Hsiao, Taipei (TW); Wen-Shen Yang, Taipei (TW)

Correspondence Address: BIRCH STEWART KOLASCH & BIRCH, PO BOX 747, FALLS CHURCH, VA, 22040-0747, US

(21) Appl. No.: 09/758,179

(22) Filed: Jan. 12, 2001

(51) Int. Cl. F21S 15/00

(52) U.S. Cl. 362/565; 362/161; 362/810

(57) ABSTRACT

A light-effect producing candle for illuminating and generating altering light-effect includes a light-generating means located inside a transparent candle. The light-generating means includes a plurality of light-generating devices of different colors. An optical fiber is provided to receive and transmit photo signal generated by a lighted wick, and to activate the light-generating devices to produce flickering light which may emanate through the candle for producing flickering and altering light effect around the candle.

### FIELD OF THE INVENTION

This invention relates to a candle and particularly a light-effect producing candle that its body generates altering visual light-effect when the wick of the candle is burning.

### BACKGROUND OF THE INVENTION

In the old days, candle is mainly used for illuminating purpose. When the candle is lighted, it produces flame which serves as a lighting source. However with the invention of light bulb, the technique of converting electricity energy to light energy has been widely used. Numerous electronic lighting devices have almost totally replaced illuminating function of the candle. Although the illuminating role of candle is diminishing in modern time, it still has some other functions which are not replaceable. For instance, when electricity power supply is interrupted or not available because of blackout or other reasons, candle is still the mostly used backup lighting source. In oriental countries, candle is an essential article in worship ceremony and religious events. In western countries, candle lighting is still widely used in the intimate occasions such as dating and candlelight dinner because of its unique soft and flickering light nature may foster romantic atmosphere. Hence candle is not totally obsolete in modern life after all.

Candle is made of combustible materials such as wax and the like. It is generally shaped in a cylindrical or barrel form with a cotton wick located in the center. The wick has one end extended out of the top end of the candle. The wick will burn and produce flame when lit until the wick and wax are consumed.

There are electronic candles and other electronic gadgets and devices being developed and proposed over the years trying to replace candle. For instances, U.S. Pat. Nos. 4,187, 532; 4,228,885; 4,492,896; 5,152,602; 5,600,209; 5,863,108; 6,017,139 are some of the known prior art. The devices they proposed mostly have the form of candle but use light bulb to substitute the wick. The light bulb is energized by electricity power for producing light. They do not produce flame and may avoid the risk of incidental burning, and may generate light for a long period of time without the need of replenishing, however they cannot generate the unique soft and soothing feeling which candlelight and flame emanates. Hence whether in oriental countries for religion worshipping purpose or in western countries for fostering romantic feeling, the real candle is still being used.

As a result, in some western countries music producing candles have been developed and introduced to fulfill such needs of creating romantic feeling in dating. Those music producing candles usually have a music generating means. When the candle is lighted, the music generating means immediately produces music to add romantic effect. Reference can be found in U.S. Pat. Nos. 4,477,249; 4,568,269; 4,804,323; 4,983,119; 5,015,175; 5,174,645; 5,921,767; 6,033,209 and 6,074,199.

Among those prior arts, U.S. Pat. No. 4,477,249 discloses a Flame-Producing Sound-Emitting Device which employs an optical fiber located beside the candle wick. The optical fiber has a lower end leading to a circuit board for driving a sound generating means to produce music stored in the memory when the optical fiber receives light from the lit wick. The wick is made of cotton threads while the optical fibers is made of plastic and has a smaller diameter than the wick. The optical fiber's melting rate is faster than the wick's burning rate. And such design will result in the optical fiber buried by the melted wax and cannot receive light properly, and consequently cannot function properly to produce music as desired.

U.S. Pat. No. 5,91,767 discloses another Music Producing Candle which tries to resolve the problem encountered by U.S. Pat. No. 4,477,249. It has the optical fiber embedded inside the wick so that the optical fiber and wick will burn at same speed. As the wick and optical fiber are bound together and run through the base to make contact with the circuit, when the wick burns to the bottom end, the circuit will be burned too. Furthermore, the optical fiber is surrounded by the wick which is made of twisted cotton threads, the wick is prone to block the optical fiber from receiving light adequately, and may result in not effective light receiving and transmission of the optical fiber.

Moreover, music producing candle has to equip a speaker to generate audio sound, and the speaker normally has to have enough resonant space to produce sound with satisfactory quality. The base for housing the speaker or the space between the base and table top where the candle is placed has to reserve the resonant space needed. It means that the base will always be visible and that might spoil the overall appearance of the candle.

### SUMMARY OF THE INVENTION

It is a primary object of this invention to provide a light-effect producing candle that is capable of generating flickering light alteration from inside of the candle when lit to emit changing light through the candle for increasing amusing and romantic effect. This invention differs from the conventional music producing candles. Instead of generating music to add romantic effect, this invention aims at creating visual light effect to foster romantic atmosphere.

Another object of this invention is to employ optical fiber to transmit signal and produce light-effect desired, and especially a novel structure in which the optical fiber winds around the wick in a helical manner. Because of such design, the speed of optical fiber's melting and wick's burning will be the same, and the optical fiber will not be blocked by the wick so that the optical fiber may transmit photo signal effectively to activate the light-effect producing means for generating light-effect desired.

A further object of this invention is to provide a light-effect candle that has same outside appearance as ordinary candles do. The candle of this invention does need extra resonant space as conventional music producing candles do. The light-effect producing means of this invention may be totally embedded in the candle without exposing outside. The electronic devices needed are not visible from outside and will not impair the candle appearance. The candle thus may be designed with more flexibility and may be shaped in various forms desired without limitation.

The main difference of the light-effect candle of this invention and ordinary candles is that the candle in accordance with this invention has a light generating means located inside. The light generating means include a plurality of light generating devices, a control IC chip (integrated circuit chip) which controls the flickering sequence of the light generating devices and an optical sensor. Furthermore there is an optical fiber winds around the candle wick in a helical manner so that the optical fiber's melting rate and the wick's burning rate will be simultaneous. The optical fiber will transmit photo signal resulting from the burning wick to the optical sensor. The control IC chip receives the photo signal and activates the light generating devices to produce altering flicker light whereby to create a special visual effect for enhancing romantic atmosphere.

### BRIEF DESCRIPTION OF THE DRAWINGS

The invention, as well as its many advantages, may be further understood by the following detailed description and drawings, in which:

FIG. 1 is a schematic view showing the construction of this invention.

FIG. 2 is an electric circuit diagram of this invention.

FIG. 3 is a schematic view of another embodiment of the wick and optical fiber assembly of this invention.

FIG. 4 is a schematic view of yet another embodiment of the wick and optical fiber assembly of this invention.

FIG. 5 is a second embodiment of electric circuit diagram of this invention's light generating means.

FIG. 6 is third embodiment of electric circuit diagram of this invention's light generating means.

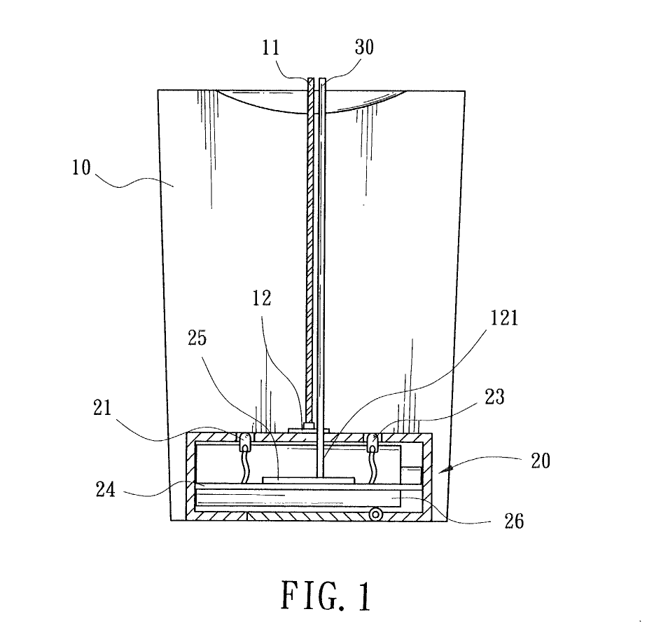

### DESCRIPTION OF THE PREFERRED EMBODIMENTS Referring to FIG. 1, the light-effect producing candle according to this invention includes a candle 10, a light generating means 20 and an optical fiber 30.

The candle is made of combustible material such as wax and is generally shaped in a cylindrical form, or in any other forms desired, such as animals, cartoon characters and the like. Fragrance essence may also be added in the candle 10 for creating more appealing effect. In order to meet the purpose of this invention, the candle 10 should be light transparent so that light is able to emanate from inside of the candle to outside. Of course the candle 10 may be made with different colors, but still should have light transparency. At the centerline of the candle 10, there is a wick 11 made of wrapping a plurality of cotton threads. The wick 11 has one end extended upward and beyond the top end of the candle 10, and another end extended downward to the lower portion of the candle 10 and reaching a separation plate 12 made of a metallic material. Hence when the wick 11 is lighted, it will burn gradually until reaching the separation plate 12 then extinguished. The separation plate 12 has an aperture 121 formed therein.

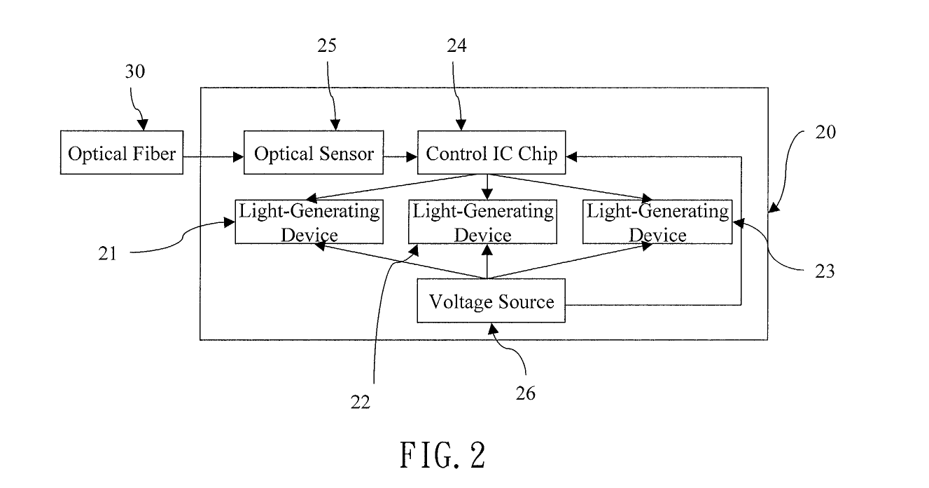

The light generating means 20 is located inside the candle 10 and is completely covered by the same. It includes a plurality of light-effect generating devices 21, 22, and 23, a control IC chip 24, an optical sensor 25 and a voltage source 26 (shown in FIG. 2). The light-generating devices 21, 22 and 23 may be light emitting diodes (LED) or light bulbs, and are preferably capable of generating light of different colors for creating altering visual effect. The control IC chip 24 is used for controlling the light-generating devices to produce sequenced light flickering effect. The optical sensor 25 receives photo signal and generates a driving signal to activate the control IC chip 24. The voltage source 26 provides electric power needed for the light-generating means 20, and may be a battery.

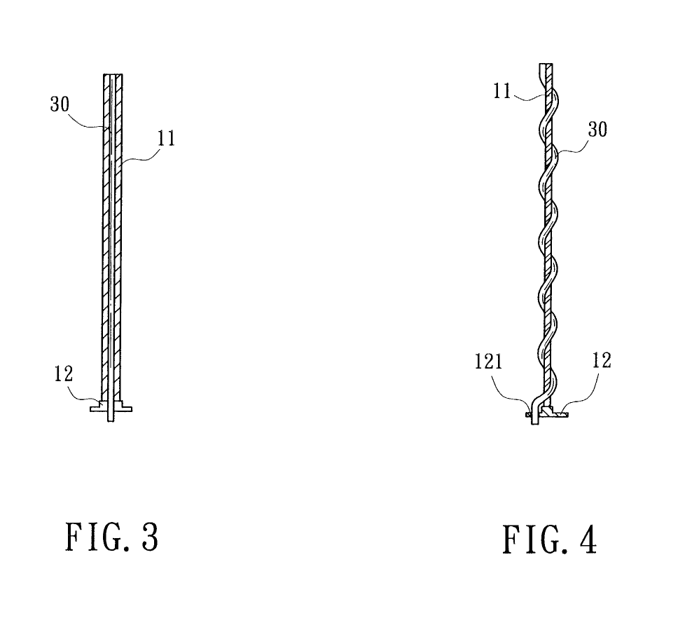

The optical fiber 30 is axially located in the candle 10 and may be abutted to the wick 11 as shown in FIG. 1, or be embedded inside the wick 11 as shown in FIG. 3. One end of the optical fiber 30 runs through the aperture 121 of the separation plate 12 and links with the optical sensor 25. When the wick 11 is lighted and burn, the generated light will be absorbed by the optical fiber 30 which transmits the photo signal to the optical sensor 25. The two schemes set forth above have been taught in U.S. Pat. No. 4,477,249 and 5,921,767. While this invention may also adapt aforesaid arrangements for the optical fiber 30, the light-effect generating means 20 of this invention offers a construction which is different from aforesaid musical devices. As optical fiber 30 located beside the wick 11 might result in different burning speed and affect photo signal transmission, and the optical fiber 30 embedded inside the wick 11 might get blocked from photo signal transmission, this invention offers a third arrangement scheme for the photo fiber 30. As shown in FIG. 4, the optical fiber 30 is wound around the wick 11 in a helical manner, whereby the problems of different burning speed or photo signal blocked by the wick 11 will be resolved.

Referring to FIGS. 1 and 2, when the wick 11 is lighted and burns, light generated by the wick 11 will be received by the optical fiber 30, and through the optical fiber 30 the photo signals will be transmitted to the optical sensor 25. After receiving the photo signals, the optical sensor 25 will generate a driving signal to the control IC chip 24 which in turn activates the light-generating devices 21, 22 and 23 to emit light and produce visual effect by selected time sequence, such as becomes brighter or dimmer gradually, flickering sequentially or alternately, and the like. All these altering visual effect may be controlled by the control IC chip 24. Light emitted from the light-generating devices 21, 22 and 23 emanates from inside of the candle 10 to outside, and will produce changing visual effect. When the flame of the wick 11 is extinguished, photo signal is stopped, then the light-generating devices 21, 22 and 23 will stop function immediately.

In the foregoing embodiment of this invention, the light-generating means 20 is completely encased in the candle 10. Hence the added devices and features of this invention will not be visible from outside of the candle 10. The appearance and form of the candle 10 thus may be designed and made flexibly without restriction.

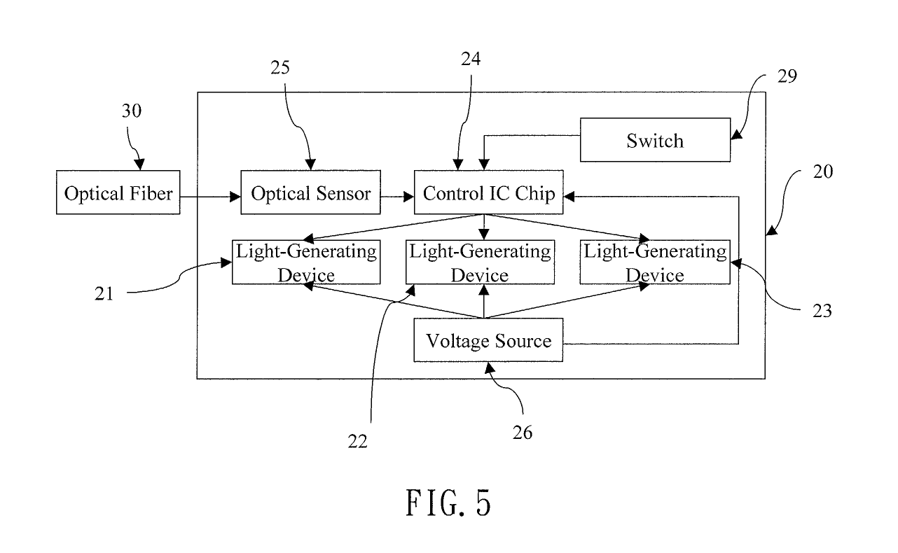

FIG. 5 depicts second embodiment of electric circuit of this invention's light generating means 20. In the first embodiment, control IC chip 24 could accept the sequenced flickering of light-generating devices 21, 22 and 23 by optical sensor 25 through optical fiber 30. The second embodiment of light generating means 20 could function without burning wick 11, and control the sequenced flickering of light-generating devices' 21, 22 and 23 by another way. Light generating means 20 including a switch 29 which connected to control IC chip 24 electrically. Switch 29 could change the state of control IC chip 24 to accept sensor's 25 signal or not, or control directly control IC chip 24 to activate the sequenced flickering of the light-generating devices 21, 22 and 23. So the Light generating means 20 can active the sequenced flickering of the light-generating devices 21, 22 and 23 by burning wick 11 or turn on the switch 29.

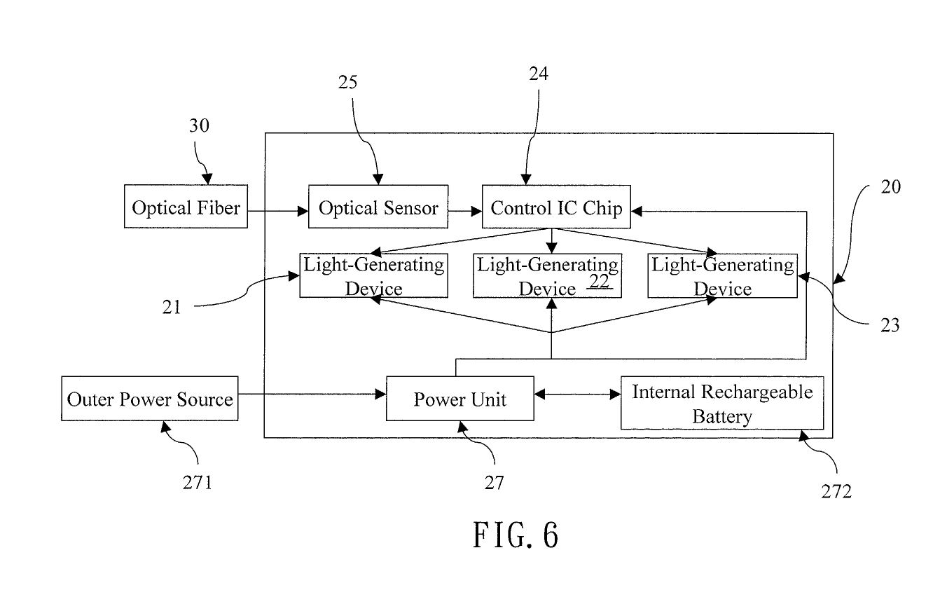

FIG. 6 depicts third embodiment of electric circuit of this invention's light generating means 20. In the above two embodiments, voltage source 26 is both used to supply the power that light generating means 20 need. And the third embodiment of light generating means 20 can be supplied power by outer power source 271. Light generating means 20 including power unit 27 which connects to control IC chip 24 and light-generating devices 21 22 and 23 to supply needed power. Power unit 27 also connects to internal rechargeable battery 272 and outer power source 271. So the needed power can be supplied by voltage source 26 or outer power source 271. While the outer power source 271 connects to power unit 27, rechargeable battery 272 can be charged.

The light-effect producing candle according to this invention is a real candle. It is different from the conventional electronic candles. This invention produces altering visual light effect which is also different from the music producing candles known in the prior art. The flickering and changing light effect generated by the body of the candle is amusing and may augment romantic atmosphere.

It may thus be seen that the objects of the present invention set forth herein, as well as those made apparent from the foregoing description, are efficiently attained. While the preferred embodiments of the invention have been set forth for purpose of disclosure, modifications of the disclosed embodiments of the invention as well as other embodiments thereof may occur to those skilled in the art. Accordingly, the appended claims are intended to cover all embodiments that do not depart from the spirit and scope of the invention.

What is claimed is:

1. A light-effect producing candle, comprising:
a candle made of a combustible material being light transparent and having a wick with one end extended outside the top end thereof;
a meltable optical fiber having an upper end extended outside the top end of the candle for receiving light generated by the wick when lighted and a lower end extended downward to the bottom end of the candle; and
a light generating means encased in the candle including at least one light-generating device and one optical sensor connected with the optical fiber for sensing light transmitted from the optical fiber and activating the light-generating device to emanate light through the candle.

2. The light-effect producing candle of claim 1, wherein the combustible material is wax.

3. The light-effect producing candle of claim 1, wherein the number of the light-generating device is more than one.

4. The light-effect producing candle of claim 3, wherein the light-generating devices have different colors for generating different colors of light.

5. The light-effect producing candle of claim 1, wherein the light-generating device is a light emitting diode.

6. The light-effect producing candle of claim 1, wherein the light-generating device is a light bulb.

7. The light-effect producing candle of claim 1 further including a voltage source for providing electric power.

8. The light-effect producing candle of claim 7, wherein the voltage source is a battery.

9. The light-effect producing candle of claim 1, wherein the light generating means further includes a control integrated circuit chip for controlling a plurality of the light-generating devices to produce sequenced flickering for generating different and altering colorful light.

10. The light-effect producing candle of claim 1, wherein the light generating means comprising a switch which connects to the control integrated circuit chip electrically, the switch can optionally control the activate of the light-effect generating devices' sequenced flickering by the optical fiber passing the optical signals or the switch.

11. The light-effect producing candle of claim 1, wherein the light generating means further comprising a power unit connects to the integrated circuit chip and the light-effect generating devices electrically, the power unit also connects to an internal rechargeable battery and a outer power source to optionally charge by the rechargeable battery or the outer power source.

12. The light-effect producing candle of claim 1 further having a separation plate located below the bottom end of the wick for stopping the wick from continuous burning.

13. The light-effect producing candle of claim 1, wherein the optical fiber is abutted to the wick.

14. The light-effect producing candle of claim 1, wherein the optical fiber is embedded in the wick.

15. The light-effect producing candle of claim 1, wherein the optical fiber is wound around the wick.

16. A light-effect producing candle, comprising:
a candle made of a combustible material being transparent and having a wick located therein which has one end extended outside the top end of the candle;
a meltable optical fiber wound around the wick having an upper end extended outside the top end of the candle for receiving light generated by the wick when lighted and a lower end extended downward to the bottom end of the candle; and
a light generating means including at least one light-generating device and an optical sensor connected with the optical fiber for sensing light transmitted from the optical fiber and activating the light-generating device to emanate light through the candle.

17. The light-effect producing candle of claim 16, wherein the combustible material is wax.

18. The light-effect producing candle of claim 16, wherein the number of the light-generating device is more than one.

19. The light-effect producing candle of claim 18, wherein the light-generating devices have different colors for generating different colors of light.

20. The light-effect producing candle of claim 16, wherein the light-generating device is a light emitting diode.

21. The light-effect producing candle of claim 16, wherein the light-generating device is a light bulb.

22. The light-effect producing candle of claim 16, wherein the light generating means further includes a voltage source for providing electric power.

23. The light-effect producing candle of claim 22, wherein the voltage source is a battery.

24. The light-effect producing candle of claim 16, wherein the light generating means further includes a control integrated circuit chip for controlling a plurality of the light-generating devices to produce sequenced flickering for generating different and altering colorful light.

25. The light-effect producing candle of claim 16, wherein the light generating means comprising a switch which connects to the control integrated circuit chip electrically, the switch can optionally control the activate of the light-effect generating devices sequenced flickering by the optical fiber passing the optical signals or the switch.

26. The light-effect producing candle of claim 16, wherein the light generating means further comprising a power unit connects to the integrated circuit chip and the light-effect generating devices electrically, the power unit also connects to an internal rechargeable battery and a outer power source to optionally charge by the rechargeable battery or the outer power source.

27. The light-effect producing candle of claim 16 further having a separation plate located below the bottom end of the wick for stopping the wick from continuous burning

28. A light-effect producing candle, comprising:
a candle made of a combustible material being transparent and having a wick which has one end extended outside the top end of the candle; and
a meltable optical fiber wound around the wick.

29. The light-effect producing candle of claim 28, wherein the combustible material is wax.

30. The light-effect producing candle of claim 28 further having a light generating means connected with the optical fiber for receiving light transmitted from the optical fiber and being activated whereby.

31. The light-effect producing candle of claim 30, wherein the light-generating means further includes:
a plurality of light-generating devices;
a control integrated circuit chip for controlling the light-generating devices to produce sequenced and altering flickering light;
an optical sensor connected with the optical fiber for receiving photo signal and activating the control IC, and
a voltage source for supplying electric power.

32. The light-effect producing candle of claim 31, wherein the light-generating devices have different colors for generating different colors of light.

33. The light-effect producing candle of claim 31, wherein the light-generating devices are light emitting diodes.

34. The light-effect producing candle of claim 31, wherein the light-generating devices are light bulbs.

35. The light-effect producing candle of claim 31, wherein the voltage source is a battery.

36. The light-effect producing candle of claim 31, wherein the light generating means comprising a switch which connects to the control integrated circuit chip electrically, the switch can optionally control the activate of the light-effect generating devices' sequenced flickering by the optical fiber passing the optical signals or the switch.

37. The light-effect producing candle of claim 31, wherein the light generating means further comprising a power unit connects to the integrated circuit chip and the light-effect generating devices electrically, the power unit also connects to an internal rechargeable battery and a outer power source to optionally charge by the rechargeable battery or the outer power source.
